(19) United States
(12) Patent Application Publication
(10) Pub. No.: US 2026/0360971 A1
(43) Pub. Date: Nov. 12, 2026

(54) ATTACHMENT STRUCTURE FOR ON-VEHICLE ANTENNA DEVICE

(71) Applicant: KABUSHIKI KAISHA TOYOTA JIDOSHOKKI, Kariya-shi, Aichi (JP)

(72) Inventor: Muneaki INAGAKI, Kariya-shi, Aichi (JP)

(73) Assignee: KABUSHIKI KAISHA TOYOTA JIDOSHOKKI, Kariya-shi, Aichi (JP)

(21) Appl. No.: 18/863,249

(22) PCT Filed: Apr. 26, 2023
(86) PCT No.: PCT/JP2023/016509

§ 371 Date: Jul. 26, 2026

(30) Foreign Application Priority Data
May 20, 2022 (JP) 2022-082966

(51) Int. Cl. H01Q 1/42; H01Q 1/32

(52) U.S. Cl. CPC H01Q 1/42; H01Q 1/3275

(57) ABSTRACT

An attachment structure for an on-vehicle antenna device is an attachment structure for an on-vehicle antenna device configured to attach an on-vehicle antenna device including an antenna body and an antenna cover to a roof of a vehicle, the attachment structure including a base made of metal to which the antenna body is attached, and a resin roof to which the antenna cover is attached so as to cover the antenna body. The resin roof includes an opening through which the base or the antenna body is inserted inside an outer peripheral portion of the antenna cover. The outer peripheral portion of the antenna cover is joined to the resin roof with an adhesive around the opening.

### TECHNICAL FIELD

The present disclosure relates to an attachment structure for an on-vehicle antenna device.

### BACKGROUND ART

As an on-vehicle antenna device attached on a roof of a vehicle, for example, an on-vehicle antenna device disclosed in Patent Literature 1 is conventionally known. Patent Literature 1 discloses an on-vehicle antenna device attached to a vehicle body roof including an antenna base including a base made of metal and an antenna case covering the antenna base. An annular seal member is provided between the antenna base and the vehicle body roof. In this on-vehicle antenna device, a seal member not between an outer peripheral portion of the antenna case and a vehicle body but between the antenna base and the vehicle body roof is mainly used to prevent water ingress.

### CITATION LIST

### Patent Literature

Patent Literature 1: Japanese Unexamined Patent Publication No. 2016-32166

### SUMMARY OF INVENTION

### Technical Problem

Incidentally, in a case where a roof of a vehicle is formed of a resin roof, ground potential of an antenna body is required. Therefore, a structure is considered in which a base made of metal is provided on the interior side of the vehicle of the resin roof and the antenna body is arranged on the base so as to protrude through an opening provided on the resin roof. In this configuration, the opening of the resin roof is located inside the outer peripheral portion of the antenna case. Therefore, when a water sealing structure of the conventional technology described above is applied as it is, there is a possibility that water ingresses the inner side with respect to the outer peripheral portion of the antenna case along the resin roof and reaches the opening of the resin roof.

Therefore, in order to ensure a water sealing function between the outer peripheral portion of the antenna cover and the resin roof, a water sealing structure is considered in which the outer peripheral portion of the antenna cover is fixed to the resin roof via a seal member using the seal member and a fastening member. In this case, a certain space for accommodating the fastening member inside the outer peripheral portion of the antenna cover is required. Therefore, it has been difficult to downsize the outer peripheral portion of the antenna cover, and there has been a problem that an external appearance design of the antenna cover is restricted.

An object of the present disclosure is to provide an attachment structure for an on-vehicle antenna device capable of downsizing an outer peripheral portion of an antenna cover.

### Solution to Problem

An aspect of the present disclosure is an attachment structure for an on-vehicle antenna device configured to attach an on-vehicle antenna device including an antenna body and an antenna cover to a roof of a vehicle, the attachment structure including a base made of metal to which the antenna body is attached, and a resin roof to which the antenna cover is attached so as to cover the antenna body, in which the resin roof includes an opening through which the base or the antenna body is inserted inside an outer peripheral portion of the antenna cover, and the outer peripheral portion of the antenna cover is joined to the resin roof with an adhesive around the opening.

In an aspect of the present disclosure, the outer peripheral portion of the antenna cover is joined to the resin roof with an adhesive around the opening. By bonding with the adhesive, a fixing function to the resin roof and a water sealing function with the resin roof in the outer peripheral portion of the antenna cover are implemented in a small space. Therefore, for example, a space for accommodating a fastening member inside the outer peripheral portion of the antenna cover becomes unnecessary, and there is room for narrowing a shape of the outer peripheral portion of the antenna cover. Therefore, according to the attachment structure for an on-vehicle antenna device according to an aspect of the present disclosure, the outer peripheral portion of the antenna cover can be downsized.

In one embodiment, the outer peripheral portion of the antenna cover may be joined to the resin roof with the adhesive over an entire circumference of the opening. In this case, by bonding with the adhesive, the fixing function to the resin roof and the water sealing function with the resin roof in the outer peripheral portion of the antenna cover are implemented over the entire circumference of the opening.

In one embodiment, a first protrusion may be formed on the outer peripheral portion of the antenna cover inside an end edge of the antenna cover, the first protrusion may include a joint surface facing a surface of the resin roof, and the adhesive may be placed between the joint surface and the resin roof. In this case, since it becomes difficult for the adhesive to protrude from the end edge of the antenna cover, for example, as compared with a configuration in which the adhesive is placed between the end edge of the antenna cover and the resin roof, the on-vehicle antenna device can be easily attached with an excellent appearance.

In one embodiment, the resin roof may include a through hole provided between a portion adhered to the antenna cover and an edge of the opening, a second protrusion may be formed on the outer peripheral portion of the antenna cover inside an end edge of the antenna cover, and the second protrusion may be fixed by a fixing member extending in a direction intersecting an extending direction of the through hole in a state of being inserted into the through hole. In this case, the on-vehicle antenna device can be more reliably attached to the roof by the second protrusion and the fixing member.

In one embodiment, the resin roof may include an engagement edge formed on a portion of an edge of the opening, and the antenna cover may include a third protrusion having a cross-sectional shape that engages with the engagement edge. In this case, by engaging the third protrusion with the engagement edge, the antenna cover can be positioned with respect to the resin roof.

### Advantageous Effects of Invention

According to the present disclosure, an outer peripheral portion of an antenna cover can be downsized.

### BRIEF DESCRIPTION OF DRAWINGS

FIG. 1 is a schematic perspective view illustrating a part of a roof of a vehicle to which an on-vehicle antenna device is attached.

FIG. 2 is a schematic cross-sectional view of an attachment structure for an on-vehicle antenna device according to one embodiment.

FIG. 3 is a cross-sectional view illustrating a main part of the attachment structure for an on-vehicle antenna device in FIG. 2.

FIG. 4 is a cross-sectional view taken along line IV-IV in FIG. 3.

FIG. 5 is an enlarged cross-sectional view of a main part of a front side in FIG. 3.

FIG. 6 is an enlarged cross-sectional view of a main part of a rear side in FIG. 3.

(a) of FIG. 7 is a plan view for illustrating a test method of an adhesion performance (shearing). (b) is a side view for illustrating the test method of the adhesion performance (shearing).

FIG. 8 is a diagram for illustrating a test method of the adhesion performance (peeling).

FIG. 9 is a perspective view of a vehicle for illustrating a range of a resin roof.

(a) of FIG. 10 is a schematic cross-sectional view of the attachment structure for an on-vehicle antenna device according to Comparative Example 1. (b) is a schematic cross-sectional view of the attachment structure for an on-vehicle antenna device according to Comparative Example 2.

### DESCRIPTION OF EMBODIMENTS

Hereinafter, an embodiment of the present disclosure is described in detail with reference to the drawings. Note that, in the drawings, the same or equivalent elements will be denoted by the same reference sign, and the description is not repeated.

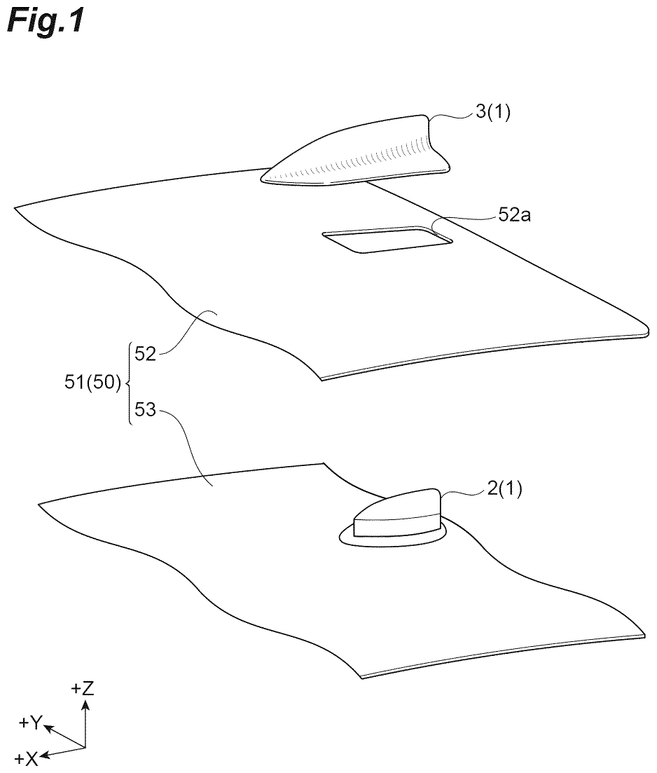

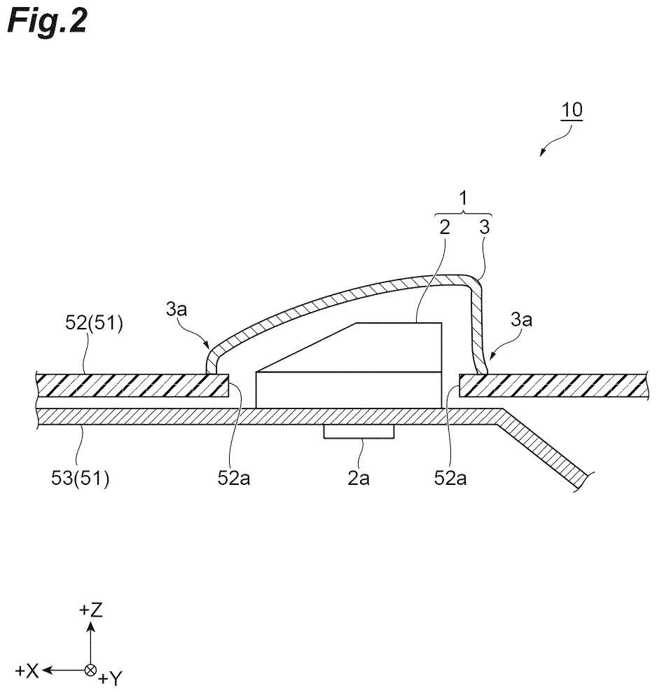

FIG. 1 is a schematic perspective view illustrating a part of a roof of a vehicle to which an on-vehicle antenna device is attached. FIG. 2 is a schematic cross-sectional view of an attachment structure for an on-vehicle antenna device according to one embodiment. In the following description, a front-rear direction of the vehicle is expressed as “front-rear direction”, a vehicle width direction of the vehicle is expressed as “left-right direction”, and a height direction of the vehicle is expressed as “up-down direction” in some cases. In each drawing, a +X direction in the drawing corresponds to a direction toward a front side of the vehicle, a +Y direction in the drawing corresponds to a direction toward a right side of the vehicle, and a +Z direction in the drawing corresponds to a direction toward an upper side of the vehicle.

FIG. 1 illustrates an on-vehicle antenna device 1 and a part of a vehicle 50 to which the on-vehicle antenna device 1 is attached. FIG. 2 is a partial cross-sectional view illustrating an internal structure of the on-vehicle antenna device 1 in a side view as viewed from a left side. As illustrated in FIGS. 1 and 2, the on-vehicle antenna device 1 is an antenna device that is attached to an upper surface of a roof 51 of the vehicle 50 such as a passenger vehicle to be used. An attachment structure for an on-vehicle antenna device 10 is an attachment structure for attaching the on-vehicle antenna device 1 to the roof 51 of the vehicle.

The roof 51 of the vehicle 50 has a double structure at least in a region in which the on-vehicle antenna device 1 is attached. The roof 51 includes a resin roof 52 and a base 53. The resin roof 52 is a plastic glazing roof panel made of resin forming an outermost portion of the roof 51 of the vehicle 50. The resin roof 52 is mainly composed of polycarbonate as a main component, for example. The resin roof 52 extends in the front-rear direction and the left-right direction corresponding to a shape of a cabin of the vehicle 50. The resin roof 52 has a substantially rectangular plate shape. A range of the resin roof 52 in the roof 51 of the vehicle 50 is not particularly limited (to be described later). The resin roof 52 may be molded in two colors or may be molded in a single color. The resin roof 52 may be subjected to hard coat treatment in order to improve weather resistance.

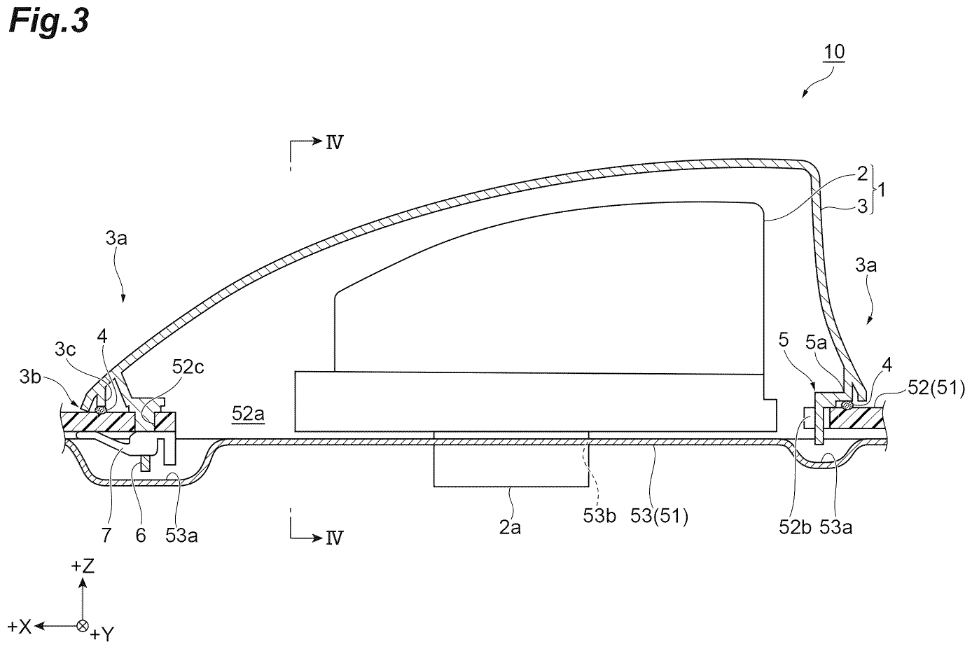

The base 53 is a panel made of metal forming an interior side (lower side) in the roof 51 of the vehicle 50, which is positioned below the resin roof 52. The base 53 extends in the front-rear direction and the left-right direction corresponding to the shape of the resin roof 52. The base 53 has, for example, a substantially rectangular plate shape having a smaller area than that of the resin roof 52. The base 53 may be partially provided with a recess 53a so as not to interfere with a member for attaching the on-vehicle antenna device 1 (refer to FIG. 3).

The on-vehicle antenna device 1 includes an antenna body 2 attached to the base 53 and an antenna cover 3 attached to the resin roof 52. The antenna body 2 is a main part for an antenna function, and is configured to include, for example, an antenna substrate such as a global navigation satellite system (GNSS) antenna. The antenna body 2 includes, for example, a fixing unit 2a that protrudes downward and is inserted into a through hole 53b of the base 53. The antenna body 2 is fixed to the base 53 by fastening or fitting the fixing unit 2a to the base 53.

The antenna cover 3 is attached to the resin roof 52 so as to cover the antenna body 2. The antenna cover 3 is formed of a resin having radio wave transparency. As the resin of the antenna cover 3, for example, a polymer alloy of polycarbonate/ABS resin (PC/ABS) or the like can be used. An external appearance of the antenna cover 3 is such that a width in the left-right direction gradually decreases from the roof 51 upward and tapers toward the front. The shape of the on-vehicle antenna device 1 is also referred to as a so-called shark fin antenna, a dolphin antenna or the like. The antenna cover 3 is attached to the resin roof 52 in an outer peripheral portion 3a of the antenna cover 3. An end edge 3b on a lower side of the outer peripheral portion 3a may be located away from a surface of the resin roof 52 by a predetermined dimension.

The resin roof 52 includes an opening 52a through which the antenna body 2 is inserted. In a state in which the on-vehicle antenna device 1 is arranged at a predetermined position of the roof 51, the opening 52a is provided inside the outer peripheral portion 3a of the antenna cover 3. The shape of the opening 52a is not particularly limited as long as the antenna body 2 can be inserted therethrough. Here, the opening 52a has, for example, a substantially rectangular shape slightly larger than a transverse cross-sectional dimension of the antenna body 2 (refer to FIG. 1).

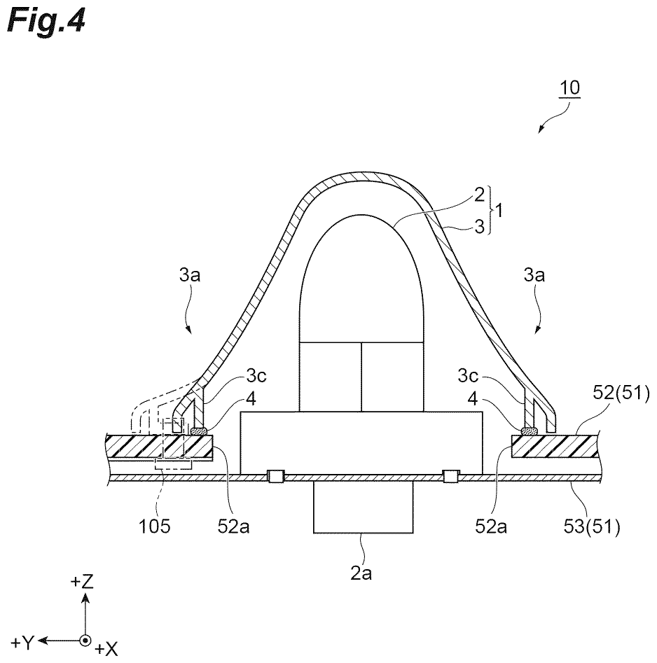

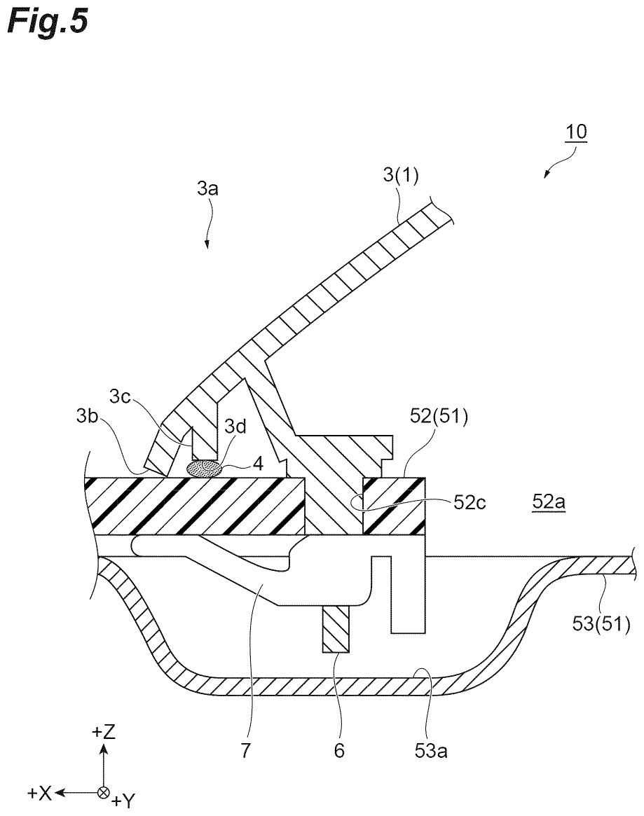

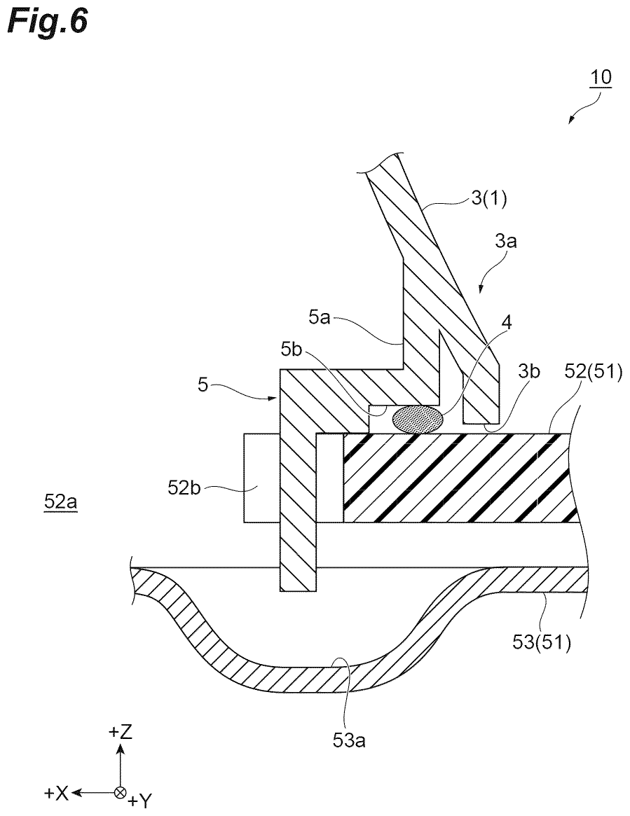

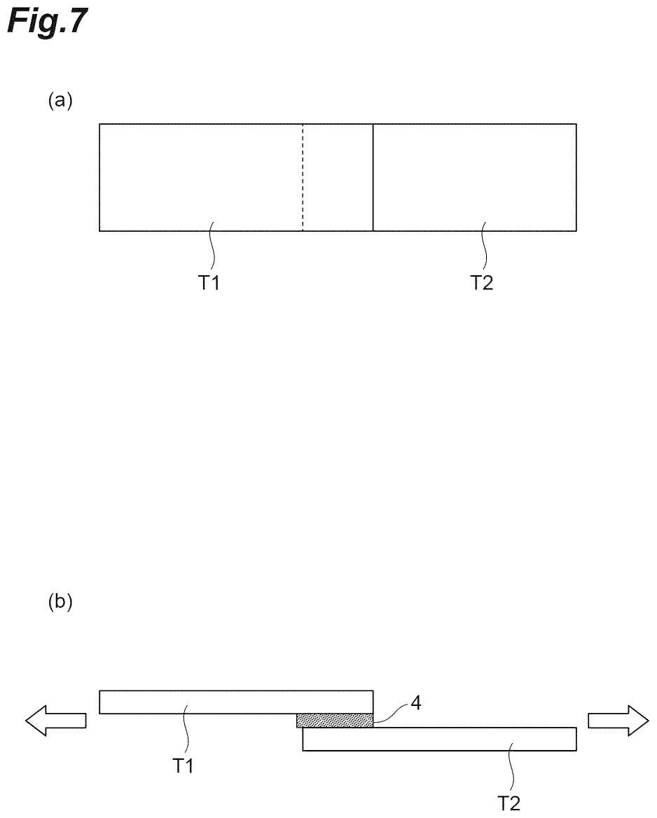

FIG. 3 is a cross-sectional view illustrating a main part of the attachment structure for an on-vehicle antenna device in FIG. 2. FIG. 4 is a cross-sectional view taken along line IV-IV in FIG. 3. FIG. 5 is an enlarged cross-sectional view of a main part of a front side in FIG. 3. FIG. 6 is an enlarged cross-sectional view of a main part of a rear side in FIG. 3. In the attachment structure for an on-vehicle antenna device 10 of the present embodiment, the outer peripheral portion 3a of the antenna cover 3 is joined to the resin roof 52 with an adhesive 4 around the opening 52a. From a viewpoint of an adhesion performance and a water sealing performance, the outer peripheral portion 3a of the antenna cover 3 may be joined to the resin roof 52 with the adhesive over an entire circumference of the opening 52a.

More specifically, a first protrusion 3c is formed on the outer peripheral portion 3a of the antenna cover 3 inside the end edge 3b of the antenna cover 3. The first protrusion is a protrusion for placing (applying) the adhesive 4 at its tip for joining. Here, as an example, the first protrusion 3c is provided along an entire circumference of the outer peripheral portion 3a of the antenna cover 3. The first protrusion 3c is provided, for example, at a position on an inner side (opening 52a side) by a predetermined distance from the end edge 3b of the antenna cover 3. The first protrusion 3c can be, for example, a plate-shaped protrusion extending downward from an inner side surface of the antenna cover 3 as a base end at the position.

A cross-sectional shape of the first protrusion 3c intersecting a circumferential direction of the outer peripheral portion 3a is not particularly limited, but may be, for example, a rectangular shape. The cross-sectional shape of the first protrusion 3c may be a trapezoidal shape in which the base end on the antenna cover 3 side is inclined. For example, a tip (an end on an opposite side of the base end) of the first protrusion 3c is a joint surface 3d facing the surface of the resin roof 52. The joint surface 3d includes, for example, a flat surface extending in the front-rear and left-right directions. The flat surface of the joint surface 3d is substantially parallel to the surface of the resin roof 52. The adhesive 4 is placed between the joint surface 3d and the resin roof 52. The joint surface 3d may be separated from the resin roof 52 by a predetermined distance in consideration of adhesive strength of the adhesive in a state in which the adhesive 4 is not placed.

Specifically, as the adhesive 4, for example, any one of a two-liquid reaction type urethane-based adhesive, a two-liquid epoxy×modified silicone-based adhesive, or a one-liquid modified silicone-based adhesive can be used. The two-liquid epoxy×modified silicone means, for example, a two-liquid mixed reaction type epoxy-modified silicone-based elastic adhesive.

An evaluation result of adhesion performance of the adhesive 4 is illustrated in Table 1 below.

TABLE 1

| | | Two- | Two-liquid | One- |
|---|---|---|---|---|
| | | liquid | epoxy × | liquid |
| | | reaction type | modified | modified |
| | | urethane | silicone | silicone |
| Adhesion | Shearing | ⊚ | ∘ | ⊚ |
| performance | Peeling | ⊚ | ⊚ | ⊚ |

| | | | |
|---|---|---|---|
| Water scaling | ⊚ | ⊚ | ⊚ |
| performance | | | |

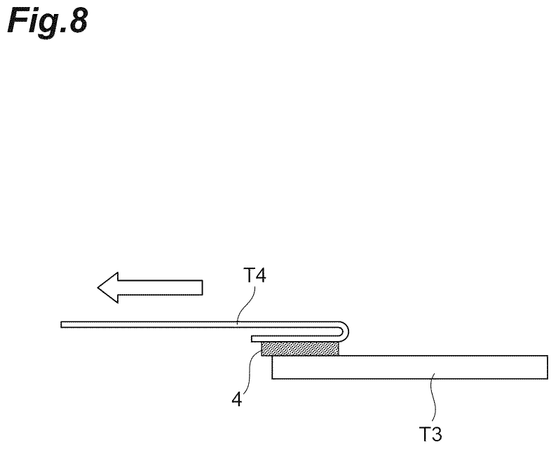

Table 1 shows the evaluation results of the adhesion performance using test pieces. (a) of FIG. 7 is a plan view for illustrating a test method of the adhesion performance (shearing). (b) of FIG. 7 is a side view for illustrating the test method of the adhesion performance (shearing). FIG. 8 is a diagram for illustrating a test method of the adhesion performance (peeling). In the evaluation of “shearing”, ends of test pieces T1 and T2 made of PC/ABS resin or PC resin with hard coat were adhered to each other at normal temperature (for example, 25 °C) in a state in which the test pieces T1 and T2 were parallel to each other as illustrated in (a) of FIG. 7. Thereafter, after a lapse of a certain time or longer, as illustrated in (b) of FIG. 7, the test pieces T1 and T2 were pulled in opposite directions in extending directions of the test pieces T1 and T2, respectively, to evaluate the adhesion performance. In the evaluation of “peeling”, as illustrated in FIG. 8, a canvas T4 was adhered to an end of a test piece T3 made of PC/ABS resin or PC resin with hard coat in such a manner that one end of the canvas T4 was folded back. After a lapse of a certain period of time or longer, the canvas T4 was pulled in a direction indicated by an arrow with respect to the test piece T3 to be peeled off, and the adhesion performance was evaluated.

The adhesion performance of the adhesive 4 is shown in “Adhesion performance” in Table 1. Particularly excellent adhesive strength was exhibited with any adhesive used (corresponding to double circle mark) except for “shearing” of the two-liquid epoxy×modified silicone. In “shearing” of the two-liquid epoxy×modified silicone, excellent adhesive strength was exhibited (corresponding to single circle mark) though weaker than the results under other test conditions. In contrast, the water sealing performance of the adhesive 4 is shown in “Water sealing performance” in Table 1. Since the outer peripheral portion of the antenna cover and the resin roof were joined to each other with the adhesive to seal a space between the outer peripheral portion of the antenna cover and the resin roof, particularly excellent water sealing performance was exhibited with any adhesive used (corresponding to double circle mark).

Note that, the first protrusion may be formed integrally with a protrusion having another function. For example, a first protrusion 5a may be formed integrally with a third protrusion 5 formed on the antenna cover 3 on the vehicle rear side.

The third protrusion 5 is a protrusion for positioning the antenna cover 3. Here, the third protrusion 5 positions the antenna cover 3 in the left-right direction on the vehicle rear side. The third protrusion 5 is provided, for example, at a position on an inner side (opening 52a side) by a predetermined distance from the end edge 3b in a rear portion of the outer peripheral portion 3a of the antenna cover 3. The third protrusion 5 is formed, for example, so as to extend downward with the inner surface of the antenna cover 3 as a base end and bend in a crank shape at the position. In such third protrusion 5, a portion from the base end on the inner side surface of the antenna cover 3 to the bending in the crank shape functions as the first protrusion 5a. On the base end side of the third protrusion 5, the first protrusion 5a is integrally formed continuously with the first protrusion 3c at a portion other than a rear end.

The third protrusion 5 is engaged with an engagement edge 52b formed on a part of an edge of the opening 52a of the resin roof 52 to position the antenna cover 3 in the left-right direction. The engagement edge 52b may be, for example, a rectangular (for example, rectangular) notch provided at a rearmost portion of the opening 52a of the resin roof 52 in plan view from above. A cross-sectional shape of the third protrusion 5 is not particularly limited as long as it can be engaged with the engagement edge 52b, but may be a rectangular shape similar to a notch shape of the engagement edge 52b.

As a joint surface 5b of the first protrusion 5a, a flat surface formed by a crank-shaped bent portion of the third protrusion 5 may be used. The joint surface 5b is, for example, a flat surface that extends in the front-rear and left-right directions and faces the resin roof 52 due to the third protrusion 5 being bent at a substantially right angle. The adhesive 4 is placed between the joint surface 5b and the resin roof 52. The joint surface 5b may be separated from the resin roof 52 by a predetermined distance in consideration of the adhesive strength of the adhesive in a state in which the adhesive 4 is not placed.

Note that, a second protrusion 6 may be formed on the outer peripheral portion 3a of the antenna cover 3 inside the end edge 3b of the antenna cover 3. The second protrusion 6 is a protrusion for restricting movement in an upward direction of the antenna cover 3. The second protrusion 6 is provided, for example, on the front side of the antenna cover 3. For example, the second protrusion 6 is inserted into a through hole 52c provided on the resin roof 52 between a portion adhered to the antenna cover 3 and an edge of the opening 52a. The second protrusion 6 is fixed by the fixing member 7 in a state of being inserted into the through hole 52c. In the second protrusion 6, for example, a groove for inserting the fixing member 7 into a predetermined position is formed so as to intersect with the extending direction of the through hole 52c. This groove is formed on a lower side of the resin roof 52 in a state in which the second protrusion 6 is inserted into the through hole 52c from an upper side of the resin roof 52. When the fixing member 7 is inserted into the groove, the fixing member 7 extends in the direction intersecting the extending direction of the through hole 52c. The second protrusion 6 is suppressed from coming out of the through hole 52c, and the movement in the upward direction of the antenna cover 3 is restricted. The fixing member 7 may be, for example, a plate-shaped U-shaped clamp fitting. The fixing member 7 may be a C ring or an E ring. The fixing member 7 may be a fixing pin (for example, a split pin or the like). In this case, a pin insertion hole may be formed in the second protrusion 6 so as to intersect the extending direction of the through hole 52c instead of the groove.

Note that, an elastic member (for example, a rubber material) that conceals a gap between the end edge 3b of the antenna cover 3 and the resin roof 52 may be interposed between the end edge 3b of the antenna cover 3 and the resin roof 52.

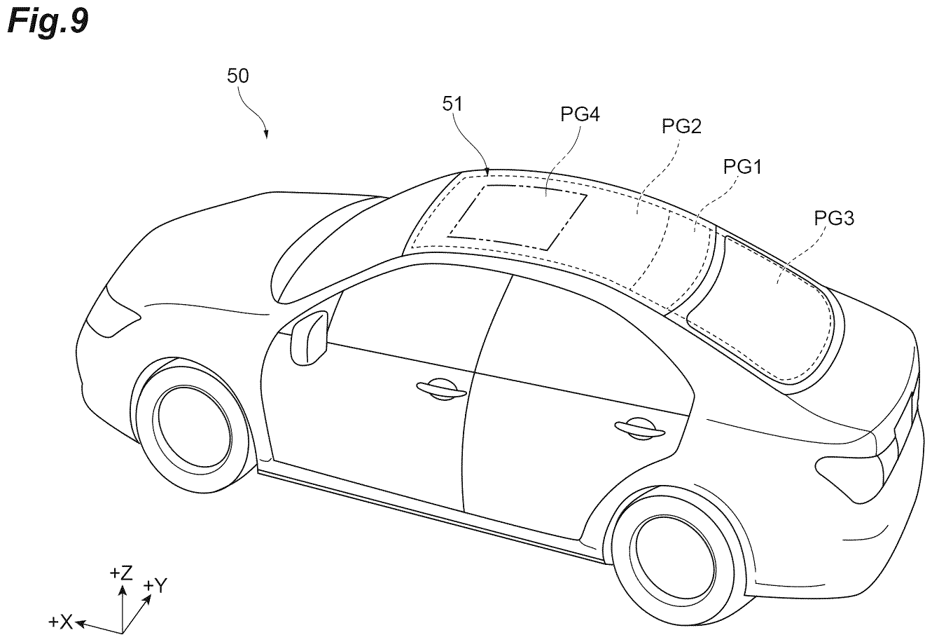

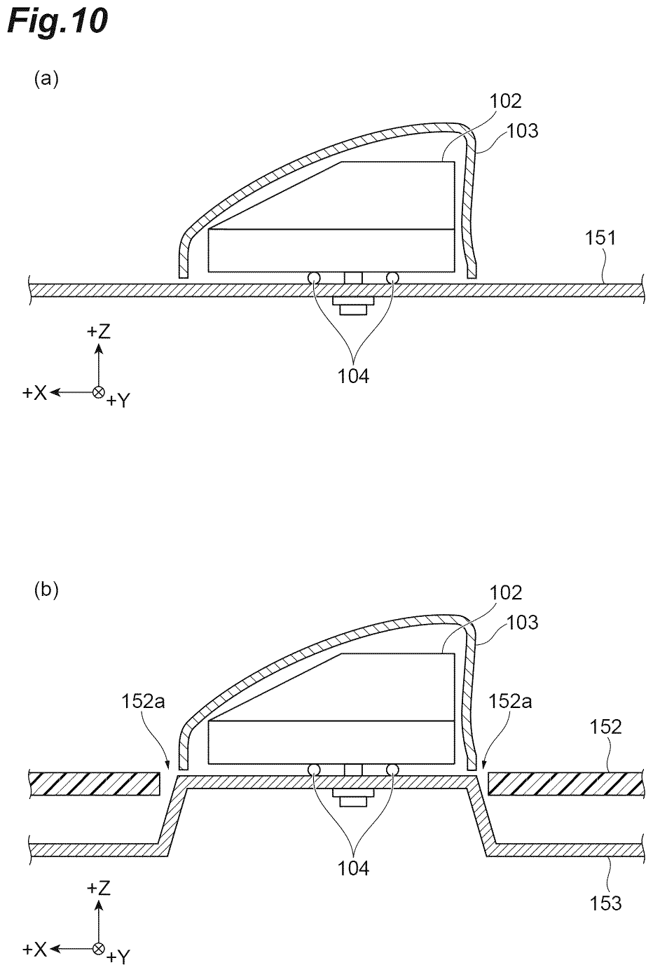

The range of the resin roof 52 in the roof 51 of the vehicle 50 can be set to any range including the portion illustrated in FIG. 1 in a front portion of a rear window. FIG. 9 is a perspective view of a vehicle for illustrating the range of the resin roof. As illustrated in FIG. 9, the range of the resin roof 52 may be only a region PG1 in a rear end portion of the roof 51 so as to correspond to an upper portion of a rear seat of the vehicle 50. The range of the resin roof 52 may be an entire region of the roof 51 obtained by adding the region PG1 and the region PG2 so as to cover the entire cabin of the vehicle 50. In a case where a resin rear window PG3 is integrally formed with the resin roof 52, the range of the resin roof 52 may be a region obtained by adding the region PG1 and the region PG3. In a case where the resin rear window PG3 is integrally formed with the resin roof 52, the range of the resin roof 52 may be a region obtained by adding the regions PG1 and PG2 to the region PG3. In a case where the resin roof 52 is molded in two colors, a transparent portion PG4 may be set in the region PG2.

A structural effect of the attachment structure for an on-vehicle antenna device 10 configured as described above will be described. (a) of FIG. 10 is a schematic cross-sectional view of the attachment structure for an on-vehicle antenna device according to Comparative Example 1. (b) of FIG. 10 is a schematic cross-sectional view of the attachment structure for an on-vehicle antenna device according to Comparative Example 2. In the structure of Comparative Example 1, the roof 151 is not made of resin but is made of conventional metal, and a gap such as the opening 52a described above is not provided. In this case, since a seal member 104 interposed between the antenna body 102 and the roof 151 exhibits a principal water sealing function, the water sealing function on the outer peripheral portion of the antenna cover 103 is not required. In the structure of Comparative Example 2, the roof includes a resin roof 152 and a base 153, and a gap 152a similar to the opening 52a described above is provided. Therefore, if the outer peripheral portion of the antenna cover 103 is arranged inside the gap 152a (on the antenna body 102 side), water might ingress the gap 152a. Therefore, the outer peripheral portion of the antenna cover 103 needs to be arranged on an outer side with respect to the gap 152a. However, even if the outer peripheral portion of the antenna cover 103 is arranged on an outer side with respect to the gap 152a, water might still ingress from between the antenna cover 103 and the resin roof 152 if only the seal member 104 is configured to exhibit the principal water sealing function as illustrated in (b) of FIG. 10. Therefore, in a case where the gap 152a such as the opening 52a described above is provided, the water sealing function between the antenna cover 103 and the resin roof 152 is required around the gap 152a such as the opening 52a described above (outer side of the gap 152a).

Therefore, in order to ensure a water sealing function between the outer peripheral portion of the antenna cover and the resin roof, a water sealing structure is considered in which the outer peripheral portion of the antenna cover is fixed to the resin roof via a seal member using the seal member and a fastening member. In FIG. 4, as a comparative example, a water sealing structure for fixing the outer peripheral portion of the antenna cover to the resin roof 52 using a fastening member 105 is indicated by two-dot chain line. In a case of the structure of the comparative example in FIG. 4, a certain space for accommodating the fastening member 105 inside the outer peripheral portion of the antenna cover is required. That is, the outer peripheral portion of the antenna cover of the comparative example has a thickness larger than a protruding height of the fastening member 105 in the upward direction in order to provide the space. The outer peripheral portion of the antenna cover of the comparative example has a shape extending outward larger than a width (for example, a dimension of an insert nut or the like) of the fastening member 105 in the front-back and left-right directions. Furthermore, since the seal member is arranged on an outer side with respect to the fastening member 105 from the viewpoint of suppressing water ingress in a fastening portion, the outer peripheral portion of the antenna cover of the comparative example tends to spread outward. In this manner, when it is difficult to downsize the outer peripheral portion of the antenna cover, an external appearance design of the antenna cover is restricted.

In this regard, according to the attachment structure for an on-vehicle antenna device 10, the outer peripheral portion 3a of the antenna cover 3 and the resin roof 52 are adhered to each other. Therefore, ingress of water to the inner side (antenna body 2 side) from the outer peripheral portion 3a of the antenna cover 3 is suppressed. As a result, it is possible to prevent water from ingress the gap between the resin roof 52 and the base 53 in the opening 52a. In this manner, by bonding with the adhesive 4, a fixing function to the resin roof 52 and the water sealing function with the resin roof 52 in the outer peripheral portion 3a of the antenna cover 3 are implemented in a small space. This eliminates the need for a space for accommodating the fastening member 105 inside the outer peripheral portion of the antenna cover as indicated by two-dot chain line in FIG. 4. As a result, there is room for narrowing the shape of the outer peripheral portion of the antenna cover. Therefore, according to the attachment structure for an on-vehicle antenna device 10, the outer peripheral portion 3a of the antenna cover 3 can be downsized.

According to the attachment structure for an on-vehicle antenna device 10, the outer peripheral portion 3a of the antenna cover 3 is joined to the resin roof 52 with the adhesive 4 over the entire circumference of the opening 52a. As a result, the fixing function to the resin roof 52 and the water sealing function with the resin roof 52 in the outer peripheral portion 3a of the antenna cover 3 are implemented over the entire circumference of the opening 52a.

According to the attachment structure for an on-vehicle antenna device 10, the first protrusion 3c is formed on the outer peripheral portion 3a of the antenna cover 3 inside the end edge 3b of the antenna cover 3. The first protrusion 3c includes the joint surface 3d facing the surface of the resin roof 52. The adhesive 4 is placed between the joint surface 3d and the resin roof 52. This makes it difficult for the adhesive 4 to protrude from the end edge 3b of the antenna cover 3. Therefore, for example, as compared with a configuration in which the adhesive 4 is placed between the end edge 3b of the antenna cover 3 and the resin roof 52, the on-vehicle antenna device 1 can be easily attached with an excellent appearance.

According to the attachment structure for an on-vehicle antenna device 10, the resin roof 52 includes the through hole 52c provided between the portion adhered to the antenna cover 3 and the edge of the opening 52a. The second protrusion 6 is formed on the outer peripheral portion 3a of the antenna cover 3 inside the end edge 3b of the antenna cover 3. The second protrusion 6 is fixed by the fixing member 7 extending in the direction intersecting the extending direction of the through hole 52c in a state of being inserted into the through hole 52c. Thus, the on-vehicle antenna device 1 can be more reliably attached to the roof 51 by the second protrusion 6 and the fixing member 7.

According to the attachment structure for an on-vehicle antenna device 10, the resin roof 52 includes an engagement edge 52b formed on a part of the edge of the opening 52a. The antenna cover 3 includes the third protrusion 5 having a cross-sectional shape that engages with the engagement edge 52b. By engaging such third protrusion 5 with the engagement edge 52b, the antenna cover 3 can be positioned with respect to the resin roof 52.

Note that, according to the attachment structure for an on-vehicle antenna device 10, for example, the fastening member 105 is not required as compared with the attachment structure using the fastening member 105, so that an increase in the number of parts can be suppressed. As compared with the attachment structure using the fastening member 105, it is possible to suppress complication of management of the fastening member 105 and an increase in cost for the fastening member 105 at the time of assembly or the like.

### [Modification]

Although the embodiment according to the present disclosure has been described above, the present disclosure is not limited to the embodiment described above.

In the embodiment described above, the outer peripheral portion 3a of the antenna cover 3 is joined to the resin roof 52 with the adhesive 4 over the entire circumference of the opening 52a, but the disclosure is not limited to this example. As long as predetermined adhesion performance can be ensured, a member other than the adhesive 4 (for example, an elastic member such as rubber or sponge) may be interposed between the outer peripheral portion 3a of the antenna cover 3 and the resin roof 52 in a part of the entire circumference of the outer peripheral portion 3a of the antenna cover 3 to achieve water sealing.

In the embodiment described above, the first protrusion 5a is formed integrally with the third protrusion 5, but may be formed separately. Although the first protrusion 3c on the front side of the vehicle is separated from the second protrusion 6, the first protrusion 3c may be formed integrally with the second protrusion 6.

In the embodiment described above, the outer peripheral portion 3a of the antenna cover 3 is adhered to the resin roof 52 via the joint surfaces 3d and 5b of the first protrusions 3c and 5a, but the disclosure is not limited to this example. For example, the end edge 3b of the outer peripheral portion 3a of the antenna cover 3 may be directly adhered to the resin roof 52.

In the embodiment described above, both the second protrusion 6 and the third protrusion 5 are provided, but at least one of the second protrusion 6 and the third protrusion 5 may be omitted.

In the embodiment described above, the antenna body 2 is inserted through the opening 52a of the resin roof 52, but the disclosure is not limited to this example. For example, the base 53 may be inserted through the opening 52a. That is, the base 53 may have a shape protruding upward from the resin roof 52 inside the opening 52a (for example, a panel shape bent in a trapezoidal shape in a cross-sectional view).

At least a part of the embodiments and various modifications described above may be optionally combined.

Note that, components of one aspect of the present disclosure are described below.

[1]

An attachment structure for an on-vehicle antenna device configured to attach an on-vehicle antenna device including an antenna body and an antenna cover to a roof of a vehicle, the attachment structure including:
a base made of metal to which the antenna body is attached; and
a resin roof to which the antenna cover is attached so as to cover the antenna body, wherein
the resin roof includes an opening through which the base or the antenna body is inserted inside an outer peripheral portion of the antenna cover, and
the outer peripheral portion of the antenna cover is joined to the resin roof with an adhesive around the opening.
   [2]

The attachment structure for an on-vehicle antenna device according to [1], wherein the outer peripheral portion of the antenna cover is joined to the resin roof with the adhesive over an entire circumference of the opening.

[3]

The attachment structure for an on-vehicle antenna device according to [1] or [2], wherein
a first protrusion is formed on the outer peripheral portion of the antenna cover inside an end edge of the antenna cover,
the first protrusion includes a joint surface facing a surface of the resin roof, and
the adhesive is placed between the joint surface and the resin roof.
   [4]

The attachment structure for an on-vehicle antenna device according to any one of [1] to [3], wherein
the resin roof includes a through hole provided between a portion adhered to the antenna cover and an edge of the opening,
a second protrusion is formed on the outer peripheral portion of the antenna cover inside an end edge of the antenna cover, and
the second protrusion is fixed by a fixing member extending in a direction intersecting an extending direction of the through hole in a state of being inserted into the through hole.
   [5]

The attachment structure for an on-vehicle antenna device according to any one of [1] to [4], wherein
the resin roof includes an engagement edge formed on a part of the edge of the opening, and
the antenna cover includes a third protrusion having a cross-sectional shape that engages with the engagement edge.

### REFERENCE SIGNS LIST

1 On-vehicle antenna device
3 Antenna cover
3a Outer peripheral portion
3b End edge
3c, 5a First protrusion
3d, 5b Joint surface
4 Adhesive
5 Third protrusion
6 Second protrusion
7 Fixing member
10 Attachment structure for on-vehicle antenna device
50 Vehicle
51 Roof
52 Resin roof
52a Opening
52b Engagement edge
52c, 53b Through hole
53 Base

1. An attachment structure for an on-vehicle antenna device configured to attach an on-vehicle antenna device including an antenna body and an antenna cover to a roof of a vehicle, the attachment structure comprising:
a base made of metal to which the antenna body is attached; and
a resin roof to which the antenna cover is attached so as to cover the antenna body, wherein
the resin roof includes an opening through which the base or the antenna body is inserted inside an outer peripheral portion of the antenna cover, and
the outer peripheral portion of the antenna cover is joined to the resin roof with an adhesive around the opening.

2. The attachment structure for an on-vehicle antenna device according to claim 1, wherein the outer peripheral portion of the antenna cover is joined to the resin roof with the adhesive over an entire circumference of the opening.

3. The attachment structure for an on-vehicle antenna device according to claim 1, wherein
a first protrusion is formed on the outer peripheral portion of the antenna cover inside an end edge of the antenna cover,
the first protrusion includes a joint surface facing a surface of the resin roof, and
the adhesive is placed between the joint surface and the resin roof.

4. The attachment structure for an on-vehicle antenna device according to claim 1, wherein
the resin roof includes a through hole provided between a portion adhered to the antenna cover and an edge of the opening,
a second protrusion is formed on the outer peripheral portion of the antenna cover inside an end edge of the antenna cover, and
the second protrusion is fixed by a fixing member extending in a direction intersecting an extending direction of the through hole in a state of being inserted into the through hole.

5. The attachment structure for an on-vehicle antenna device according to claim 1, wherein
the resin roof includes an engagement edge formed on a part of the edge of the opening, and
the antenna cover includes a third protrusion having a cross-sectional shape that engages with the engagement edge.
